(19) United States
(12) Patent Application Publication
(10) Pub. No.: US 2014/0172657 A1
(43) Pub. Date: Jun. 19, 2014

(54) REVERSE RATING AND APPLICATIONS TO OVERAGE BILLING

(71) Applicant: MICROSOFT CORPORATION, Redmond, WA (US)

(72) Inventors: Eric Perlin, Redmond, WA (US); Thaddeus C. Pritchett, Edmonds, WA (US)

(73) Assignee: MICROSOFT CORPORATION, Redmond, WA (US)

(21) Appl. No.: 13/720,518

(22) Filed: Dec. 19, 2012

(51) Int. Cl. G06Q 30/04

(52) U.S. Cl. CPC G06Q 30/04
USPC 705/34

(57) ABSTRACT

Methods, systems, and computer program products are provided for using reverse rating to determine the monetary value of consumption of services measured by one or more meters. A plurality of consumption readings associated with a second time may be received from a set of meters tracking consumption by a consumer. Consumption rates may be determined for the meters based on the received consumption readings and on initial consumption values from a first time prior to the second time. A monetary liability function may be determined for the consumer based on the consumption rates and a plurality of rating functions associated with the meters. A third time may be calculated based on the monetary liability function at which a monetary target is reached by the meters. The monetary target may be a monetary cap on consumption by the meters, or a monetary commitment value.

### BACKGROUND

Many services may be provided that are paid for by customers based on an amount of the services consumed. For instance, a household may consume natural gas for heating, cooking, and other reasons. The household may be charged for the gas consumption by a gas company according to an amount of the natural gas that is used. Periodically, a natural gas meter of the household may be read by the natural gas company, and the natural gas company may charge the household for the amount of natural gas used since a prior reading was taken according to a predetermined rate (e.g., dollars per cubic feet). Many other products and services may be paid for in this manner.

In some cases, a service may have an included quantity of the service that the consumer does not pay for (or pays a predetermined flat amount for). The consumer may pay for the service at a predetermined rate for amounts of the service that are consumed over the included quantity. Furthermore, the service may have a monetary cap for the consumer. The monetary cap may be used to limit the financial liability for the consumer for using the service, or for other purpose.

Various techniques may be used to determine a duration for which a metered transaction may continue, such as for the situation where there is a monetary cap. According to a first example technique, the services may be rated on every usage event to determine how much money has been used, and the determined amount may be compared with the monetary cap. However, this technique is computationally and data intensive (e.g., the consumption amount of the meter(s) has to be collected and then rated as frequently as the service is used by a consumer).

According to a second example technique, the services may be rated according to a schedule (e.g., periodically, such as on a daily basis, weekly basis, etc.) to determine how much money has been used, and the determined amount may be compared with the monetary cap. However, this technique has drawbacks, including that it frequently results in an overshoot (spending over the monetary cap) because on average, a half of the last period is over when the services are rated. This drawback can be mitigated by using a variable schedule as the monetary cap approaches (e.g., performing the rating increasingly often), but this is not easy if there are significant variations in consumption rates. The efficiency of this second technique as compared to the first technique is directly proportional to the consumption reporting rate (e.g., is more accurate the more often rating is performed). However, because of its indiscriminate nature, the second technique leads to wasted data accesses and computations being performed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for using reverse rating to determine consumption and payments due for used of metered services by consumers. The reverse rating techniques may be applied to metered services that have a monetary cap (e.g., monetary cap enforcement), to situations where metered services have a predetermined set commitment amount (e.g., monetary commitment situations), and to further metered services situations. Reverse rating may reduce a number of meter readings that are made and/or a number of rating computations relative to conventional techniques. Furthermore, the reverse rating techniques may be applied to a consumer that consumes one or more services according to a single meter or to a set of meters.

According to one method implementation, a plurality of consumption readings associated with a second time may be received from a set meters tracking consumption by a consumer. Consumption rates may be determined for the meters based on the received consumption readings and on initial consumption values from a first time prior to the second time. A monetary liability function may be determined for the consumer based on the consumption rates and a plurality of rating functions associated with the meters. A third time may be calculated based on the monetary liability function at which a monetary target is reached by the meters. The monetary target may be a monetary cap on consumption by the meters, a monetary commitment value, or may have other significance.

Implementations may be used in various applications. According to a monetary cap implementation, a system may include a consumption rate determiner, a monetary liability function determiner, a monetary target time calculator, and a consumption quota calculator. The consumption rate determiner is configured to determine a consumption rate for each of a plurality of meters tracking consumption by a consumer to generate a plurality of consumption rates. The monetary liability function determiner is configured to determine a monetary liability function for the consumer based on the consumption rates and a plurality of rating functions associated with the meters. The monetary target time calculator is configured to calculate an estimated time at which a monetary cap is reached by the meters based on the monetary liability function. The consumption quota calculator is configured to calculate a consumption quota for each of the meters at the estimated time based on a corresponding consumption rate to determine a plurality of consumption quotas for the plurality of meters.

The system may further include a trigger event monitor configured to determine at a second time that a consumption quota corresponding to a meter was reached. In response, the trigger event monitor is configured to determine whether the monetary cap is reached based on meter readings taken at the second time. An updated consumption quota is determined for each of the meters when the monetary cap is determined to not be reached. If the monetary cap was reached, one or more actions may be taken.

According to a monetary commitment value implementation, a system may include a consumption rate determiner, a monetary liability function determiner, and a monetary target time calculator. The consumption rate determiner is configured to receive a plurality of consumption readings associated with an end time of a billing cycle from a plurality of meters tracking consumption by a consumer, and to determine consumption rates for the meters based on the received consumption readings and a plurality of initial consumption values associated with a begin time of the billing. The monetary liability function determiner is configured to determine a discounted monetary liability function for the consumer based on the consumption rates and a plurality of discounted rating functions associated with the meters. The monetary target time calculator is configured to calculate an intermediate time between the begin time and the end time at which a monetary commitment value of the consumer is reached by the meters based on the discounted monetary liability function.

The system may further include a monetary value calculator configured to calculate a monetary value for consumption by the meters subsequent to the intermediate time until the end time. The monetary value calculator may calculate this monetary value for consumption using a non-discounted monetary liability function for the meters.

Computer program products containing computer readable storage media are also described herein that store computer code/instructions for performing reverse rating for overage billing with regard to multiple simultaneous meters, including applications of reverse rating to monetary cap enforcement and to monetary commitment situations, as well as enabling additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of metered service tracking system, according to an example embodiment.

FIG. 2 shows a flowchart providing a process for performing reverse rating to determine a time at which a monetary target is reached, according to an example embodiment.

FIG. 3 shows a block diagram of a reverse rating system, according to an example embodiment.

FIG. 4 shows a flowchart providing a process for determining a linear consumption rate, according to an example embodiment.

FIG. 5 shows a plot of meter reading consumption values versus time, according to an example embodiment.

FIG. 6 shows a plot of monetary liability versus time, according to an example embodiment.

FIG. 7 shows flowchart providing a process for using reverse rating with regard to a set of meters having an associated monetary cap, according to an example embodiment.

FIG. 8 shows a block diagram of a monetary cap monitoring system configured for a set of meters having an associated monetary cap, according to an example embodiment.

FIG. 9 shows a flowchart providing a process for monitoring whether a monetary cap is reached, according to an example embodiment.

FIG. 10 shows a flowchart providing a more detailed process for the flowchart of FIG. 9, according to an example embodiment.

FIG. 11 shows flowchart providing a process for using reverse rating with regard to a set of meters having an associated monetary commitment value, according to an example embodiment.

FIG. 12 shows a block diagram of a monetary commitment enforcement system configured for a set of meters having an associated monetary commitment value, according to an example embodiment.

FIG. 13 shows a flowchart providing a process for generating a bill with regard to a monetary commitment value situation, according to an example embodiment.

FIG. 14 shows a flowchart providing a process for determining a monetary value of consumption by a plurality of meters for consumption above the associated monetary commitment value, according to an example embodiment.

FIG. 15 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Many services may be provided that are paid for by customers (consumers) based on an amount of the services consumed. For example, a meter may track how much of a service is consumed, and the meter may be read to determine how much the consumer has consumed since a last time the meter was read or since the beginning of a current billing cycle. The customer may then be billed for the amount consumed. Many products and services may be paid for in this manner, such as consumption of natural gas, electricity, call minutes used by a cell phone user, text messages (e.g., SMS) sent and/or received by a device (e.g., smart phone) user, data bandwidth downloaded by a consumer to a computing device, etc.

According to embodiments, techniques of reverse rating may be used to determine aspects of consumption by metered services, including determining billing amounts for such metered services. Reverse rating may be used to determine a duration for which a metered transaction may continue. For instance, reverse rating may be used to estimate when a consumer may reach a monetary cap for a metered service that the user is using. For a system that charges its consumers based on their consumption of a set of meters, reverse rating enables the computation of future or past meter consumption based on an optional included amount of service, a rate of consumption of the services associated with the meters, and a rating function.

Reverse rating embodiments may be applied to situations where a monetary cap is present for a set of meters, and situations where a monetary commitment value is present for a set of meters. According to a monetary commitment value situation, customers receive a discount on their service overage up a monetary commitment amount that they commit to paying. “Overage” refers to service consumption that the consumer pays for at a rate (e.g., dollars per amount of resource used), as distinguished from any set amounts of service consumption that the consumer does not pay for on a rated basis (e.g., included minutes for a cell phone call plan, included text messages, etc.). “Overage” billing refers to billing for such overage service consumption.

For instance, in an example monetary cap embodiment, a consumer may have a set amount of money that the consumer is willing to pay up to for rated service, but not exceed (the monetary cap), during a time period (e.g., a month or other billing cycle time period) for one or more services being tracked by a set of meters. At any time within the time period, the current consumption can be rated according to reverse rating by reading the set of meters and determining the current monetary consumption amount. For instance, a linear consumption rate may be determined based on a difference between the current meter readings and prior meter readings. A rating function (e.g., a cost per consumption amount) may be applied to the linear consumption rate to determine the current monetary consumption amount. The amount that the current monetary consumption amount is less than the monetary cap is an amount remaining to be consumed. This remaining amount may be distributed across the set of meters to provide each meter with a consumption quota. The monetary cap is not hit unless one of the meters exceeds a previously computed quota. As such, any time a quota is met by a meter, it may be checked whether or not the monetary cap has been reached. If the monetary cap has not been reached, reverse rating may be used to again to assign new consumption quotas to the set of meters. Typically, a reason why the monetary cap is not reached when one of the quotas is exceeded is because the consumption quotas are approximations (assumptions of future consumption). These quotas are adjusted over time with each iteration (through reverse rating).

Such an embodiment has advantages over conventional techniques, because determinations of whether the monetary cap has been reached may be performed much less often (e.g., whenever a meter of the set of meters reaches its consumption quota, rather than whenever usage occurs or at a periodic rate). Preliminary results indicate that such rating may occur 350 times less often than using previous techniques that check consumption on an hourly schedule. In some cases, if the monetary cap is set properly (e.g. just high enough to make sure that consumption is not running amok), such rating may actually occur once per time period.

In an example monetary commitment value embodiment, reverse rating may be used to calculate a time at which the monetary commitment value was reached by consumption by the consumer during a billing cycle. In this manner, the consumer may pay the monetary commitment value for consumption up to that calculated time (as a discount), and may pay standard rates for subsequent consumption during the billing cycle.

For instance, FIG. 1 shows a block diagram of metered service tracking system 100, according to an example embodiment. In embodiments, reverse rating may be used in system 100 to determine monetary values of consumption at various points in time, including in the past and in the future. Furthermore, system 100 may be used to track monetary values of consumption where a monetary cap is present (e.g., to aid in avoiding exceeding of the monetary cap), to track monetary values of consumption where a monetary commitment value is present, to track monetary values of consumption in combinations of such situations (e.g., where a monetary cap and a monetary commitment value are both present), and to track monetary values of consumption in further situations.

As shown in FIG. 1, system 100 includes a vendor system 102 that may be interfaced with by a consumer 110. Vendor system 102 includes first and second services 104a and 104b, first meters 106a-106n, second meters 120a-120n, a consumption aggregator 118, and a reverse rating system 108. These features of system 100 are described as follows.

Vendor system 102 is a system managed by one or more parties, including a party that provides services to consumers such as consumer 110. Vendor system 102 may be implemented in one or more devices, including computers and/or other equipment. Any number of consumers may be serviced by vendor system 102. First and second services 104a and 104b are services that are provided to consumer 110 by vendor system 102. Although two services are shown in vendor system 102 in FIG. 1, any number of services may be provided by vendor system 102, including three services, four services, and any greater numbers of services. Services included in vendor system 102 provide respective service streams that are purchased and interacted with by consumers. For instance, as shown in FIG. 1, first service 104a generates a first plurality of service streams 114a-114n, and second service 104a generates a second plurality of service streams 122a-122n. First service streams 114a-114n and second service streams 122a-122n may be received by consumer 110 as shown in FIG. 1 (e.g., downloaded data, etc.), or may not be received by the consumer 110 (e.g., data storage transactions, etc.). Each service stream of first service streams 114a-114n and second service streams 122a-122n may be any service or product provided to consumer 110 for consumption, and that consumer 110 pays for at least partially based on an amount of the service or product that is consumed (e.g., metered services). Examples of services include data services, network bandwidth services, data storage services, CPU (central processing unit) hours, SQL (structured query logic) transactions, web sites, cache, natural gas services, oil services, water services, food services, power services, and any other metered services. As such, first service streams 114a-114n and second service streams 122a-122n include the services or products provided by first and second services 104a and 104b, such as data, network bandwidth, data storage space, computer hours, database query handling, web services, content caching, gas, oil, water, food, electricity, and any other metered services or products.

In the example of FIG. 1, two sets of meters are present. First meters 106a-106n and second meters 120a-120n are coupled to first and second services 104a and 104b, respectively. First meters 106a-106n and second meters 120a-120n track consumption by consumer 110 of first service streams 114a-114n and second service streams 122a-122n, respectively. Although 1-n meters are shown for first meters 106a-106n and for second meters 120a-120n, any number of meters (e.g., one or more meters) may be present in vendor system 102 in any set of meters tracking consumption of services by a consumer. Still further, each service may include disparate service streams having consumption that is tracked (e.g., a storage service may have both storage actually used and an amount of data that is transferred tracked by corresponding meters). First meters 106a-106n and second meters 120a-120n may be configured in any manner to track consumption of their respective services, as would be known to persons skilled in the relevant art(s). As shown in FIG. 1, first meters 106a-106n and second meters 120a-120n, generate first plurality of consumption messages 112a-112n and second plurality of consumption messages 124a-124n, respectively. First consumption messages 112a-112n and second consumption messages 124a-124n indicate consumption readings by consumer 110 of first service streams 114a-114n and second service streams 122a-122n at a time the readings are taken. For instance, first consumption messages 112a-112n and second consumption messages 124a-124n may be consumption messages that each indicates an amount or quantity of consumption for a corresponding meter as the consumption occurs.

As shown in FIG. 1, first consumption messages 112a-112n and second consumption messages 124a-124n are received by consumption aggregator 118. Consumption aggregator 118 is configured as a mediation component that aggregates consumption messages into running totals. As such, in the example of FIG. 1, for each of first consumption messages 112a-112n, consumption aggregator 118 generates a corresponding first plurality of meter readings 126a-126n, and for each of second consumption messages 124a-124n, consumption aggregator 118 generates a corresponding second plurality of meter readings 128a-128n. First meter readings 126a-126n and second meter readings 128a-128n each indicate a consumption reading as a current cumulative consumption amount (a total amount) since a last time the respective meter was reset (e.g., to a zero consumption amount) calculated as a corresponding sum of consumption message values.

Furthermore, as shown in FIG. 1, reverse rating system 108 receives first meter readings 126a-126n and second meter readings 128a-128n. Reverse rating system 108 may be implemented in one or more devices, such as a computer or other equipment. For instance, reverse rating system 108 may be implemented in a stationary or mobile computer or computing device such as a personal computer, a server, a handheld device (e.g., a Palm® device, a RIM Blackberry® device, a personal digital assistant (PDA)), a laptop computer, a notebook computer, a tablet computer (e.g., an Apple iPad™, a Microsoft Surface™, etc.), a netbook, a mobile phone (e.g., a smart phone such as an Apple iPhone, a Google Android™ phone, a Microsoft Windows® phone, etc.), or other type of computing device.

Reverse rating system 108 is configured to perform one or more reverse rating processes to generate consumption information 116. Consumption information 116 may include one or more generated parameters, such as a time in the past at which a particular monetary consumption amount of first service streams 114a-114n and second service streams 122a-122n (and optionally further service streams) is estimated to have occurred, a time in the future at which a particular monetary consumption amount of first service streams 114a-114n and second service streams 122a-122n is estimated to occur, or other consumption information.

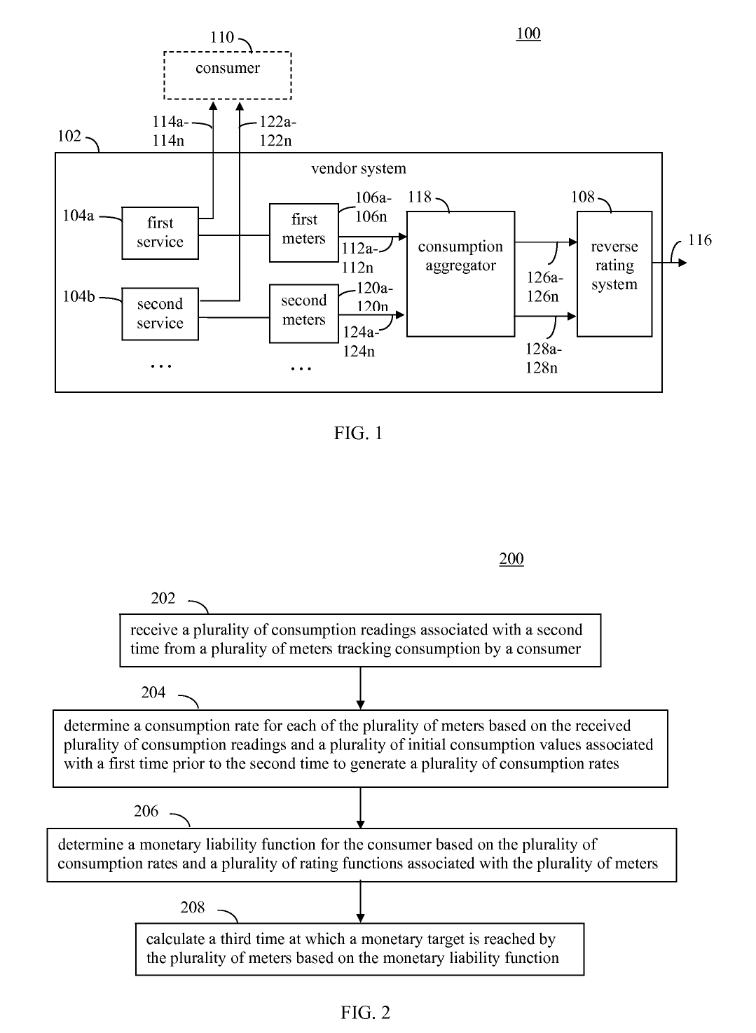

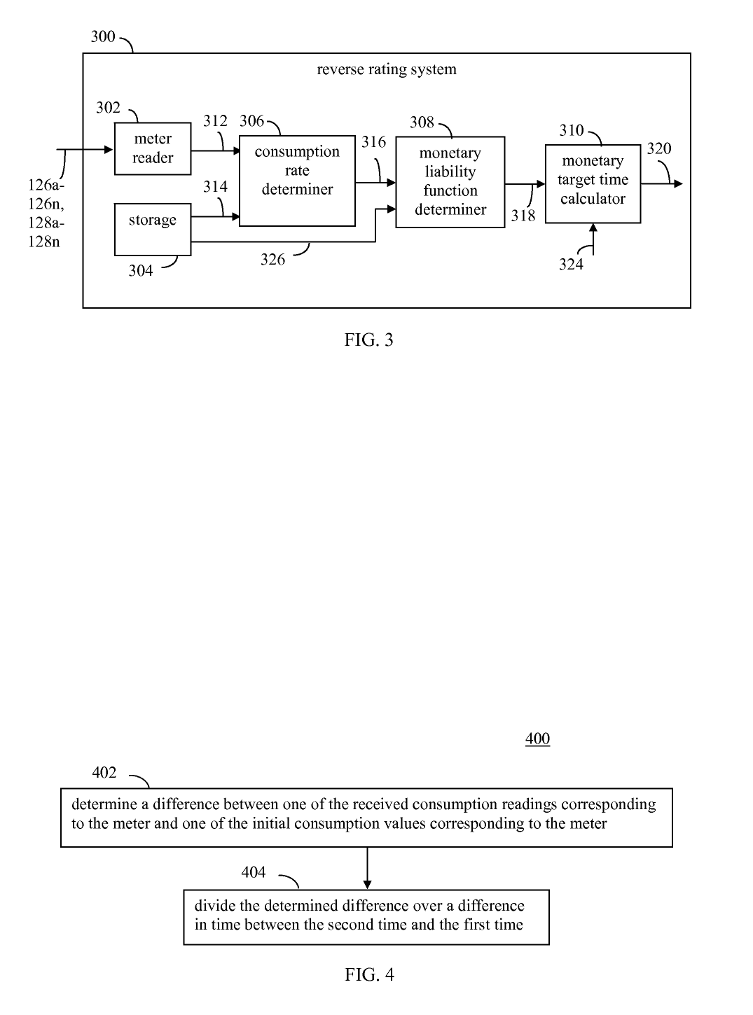

Reverse rating system 108 may be configured in various ways to perform its functions, and may operate in various ways, in embodiments. For instance, FIG. 2 shows a flowchart 200 providing a process for performing reverse rating to determine a time at which a monetary target is reached, according to an example embodiment. In an embodiment, reverse rating system 108 may operate according to flowchart 200. For purposes of illustration, flowchart 200 of FIG. 2 is described with respect to FIG. 3. FIG. 3 shows a block diagram of a reverse rating system 300, according to an example embodiment. Reverse rating system 300 is an example of reverse rating system 108 of FIG. 1. As shown in FIG. 3, reverse rating system 300 includes a meter reader 302, storage 304, a consumption rate determiner 306, a monetary liability function determiner 308, and a monetary target time calculator 310. Flowchart 200 and reverse rating system 300 are described as follows. Further structural and operational embodiments will be apparent to persons skilled in the relevant art(s) based on the following description.

Flowchart 200 begins with step 202. In step 202, a plurality of consumption readings associated with a second time is received from a plurality of meters tracking consumption by a consumer. For example, as shown in FIG. 3, meter reader 302 receives first meter readings 126a-126n and second meter readings 128a-128n. Meter readings 126a-126n and 128a-128n are consumption readings received from corresponding meters that indicate consumption by a consumer at a time meter readings 126a-126n and 128a-128n are generated. As shown in FIG. 3, meter reader 302 outputs consumption readings 312, which includes meter readings 126a-126n and 128a-128n in a processed (e.g., formatted, scaled, etc.) or non-processed form.

Meter reader 302 may include one or more of any type of interface for receiving meter readings from meters, being configured in hardware or hardware combined with software and/or firmware. For instance, in an embodiment, meter reader 302 may include a device configured to read meters in wired or wireless manner. In another embodiment, meter reader 302 may include a web service, an application programming interface (API), or other computer-based and/or network accessible interface for receiving consumption readings from meters over a network. Example networks over which consumption readings may be received include a personal area network (PAN), a local area network (LAN), a wide area network (WAN), or any combination of networks, such as the Internet.

In step 204, a consumption rate for each of the plurality of meters is determined based on the received plurality of consumption readings and a plurality of initial consumption values associated with a first time prior to the second time to generate a plurality of consumption rates. For example, as shown in FIG. 3, consumption rate determiner 306 receives consumption readings 312. Furthermore, consumption rate determiner 306 receives initial consumption values 314 from storage 304. Initial consumption values 314 includes a plurality of initial consumption values associated with the meters corresponding to consumption readings 312. For every meter reading included in consumption readings 312, initial consumption values 314 includes a corresponding initial consumption value. For instance, initial consumption values 314 may include an initial consumption value for each of first meters 106a-106n and second meters 120a-120n. The initial consumption values for the meters are for a first time that is prior to the second time for which meter readings 126a-126n and 128a-128n were received. For instance, the initial consumption values may be meter readings taken at the first time, may be initialization or reset values, such as zero values, or may be preset included quantities (e.g., a number of call minutes, a number of text messages, an amount of data, or other consumption amount that the consumer does not pay for at a rate).

In an embodiment, based on consumption readings 312 and initial consumption values 314, consumption rate determiner 306 may generate a plurality of linear consumption rates 316, which includes a linear consumption rate determined for each meter. For instance, in an embodiment, consumption rate determiner 306 may generate linear consumption rates 316 according to FIG. 4. FIG. 4 shows a flowchart 400 providing a process for determining a linear consumption rate, according to an example embodiment. Flowchart 400 is described as follows.

In step 402, a difference between one of the received consumption readings corresponding to the meter and one of the initial consumption values corresponding to the meter is determined For instance, for each meter tracking consumption by a consumer, consumption rate determiner 306 may subtract the initial consumption value included in initial consumption values 314 from the consumption reading included in consumption readings 312 to determine a difference. It is noted that for included quantities used as initial consumption values may be treated as a negative value (that is below zero).

In step 404, the determined difference is divided over a difference in time between the second time and the first time. For instance, for each meter tracking consumption by a consumer, consumption rate determiner 306 may divide the determined difference (determined in step 402) by a difference in time between the second time (when the meter reading was captured) and the first time (associated with the initial consumption value) to generate a linear consumption rate. In this manner, linear consumption rates 316 may be determined. In other embodiments, linear consumption rates 316 may be determined in other ways, as would be apparent to persons skilled in the relevant art(s) from the teachings herein.

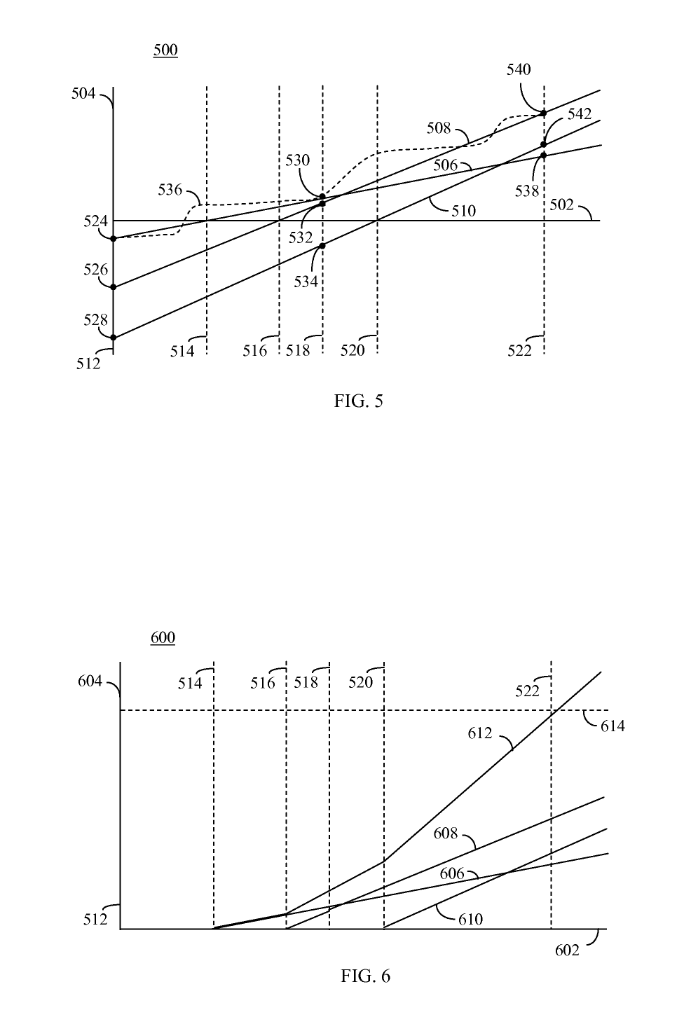

For purposes of illustration, FIG. 5 shows a plot 500 of meter reading consumption values versus time, according to an example embodiment. Plot 500 includes a first axis 502 (an X-axis) indicating time in units of time (e.g., minutes, hours, days, etc.) and a second axis 504 (a Y-axis) indicating a consumption quantity having units that depend on the particular service being consumed (e.g., call minutes, text messages, gallons, cubic feet, megabytes, etc.). Points may be plotted on plot 500 that indicate consumption quantities at particular times for any number of meters.

In the example of FIG. 5, three meters are tracked for a consumer, as examples of first-third meters 106a-106c shown in FIG. 1. For the first meter, first initial value 524 is a plot point for the initial consumption value at a first time 512 and first meter reading value 530 is a plot point for the meter reading at a second time 518. For the second meter, second initial value 526 is a plot point for the initial consumption value at first time 512 and second meter reading value 532 is a plot point for the meter reading at second time 518. For the third meter, third initial value 528 is a plot point for the initial consumption value at first time 512 and third meter reading value 534 is a plot point for the meter reading at second time 518.

Each of the three meters may indicate consumption of a respective resource at any rate, depending on how the consumer consumes the corresponding resource. For instance, the consumer may consume a resource at a constant rate, at a cyclical rate, at a randomly fluctuating rate, any combination thereof or any other rate. For instance, an actual consumption plot line 536 (shown as a dotted line) shows an example rate of consumption indicated by the first meter for a first service. As shown in FIG. 5, plot line 536 intersects with the plot points of first initial value 524 and first meter reading value 530, and otherwise fluctuates somewhat randomly. Although not indicated in FIG. 5, the second and third meters may fluctuate similarly, according to their respective rates of consumption.

However, in an embodiment, according to step 204, a linear consumption rate for each of the three meters is determined based on their corresponding initial consumption values and meter reading values. The linear consumption rate is used rather than using the actual consumption rate, which may fluctuate in a manner that is not linear as described above. Using the linear consumption rate as an estimated consumption rate advantageously simplifies calculations. For instance, according to flowchart 400, a difference may be determined for each meter by subtracting the initial consumption value at the first time from the meter reading value at the second time, and the difference may be divided by the difference between the second time and first time.

For instance, and for purposes of illustration, an example data service that provides data to a consumer that is monitored by three meters is described. The data service may provide data to the consumer that is measured in megabytes. Referring to FIGS. 3 and 5, consumption readings 312 may include the meter readings for the three meters at second time 518, and initial consumption values 314 may include initial consumption values for the three meters at first time 512. First time 512 may be 0 hours and second time 518 may be 24 hours. With regard to the first meter, first initial value 524 may be −100 megabytes (an included amount of 100 megabytes) and first meter reading value 530 may be 80 megabytes. In this example, a first linear consumption rate for the first meter may be calculated as (80−−100)/(24−0)=7.5 megabytes/hour.

Similarly, the second meter may have second initial value 526 equal to −300 megabytes and second meter reading value 532 equal to 36 megabytes, resulting in a second linear consumption rate for the second meter of (300−−36)/(24−0)=14 megabytes/hour. The third meter may have third initial value 528 equal to −500 megabytes and third meter reading value 534 equal to −120 megabytes, resulting in a third linear consumption rate for the third meter of (−100−−500)/(24−0)=16.67 megabytes/hour. These calculated linear consumption rates may be output by consumption rate determiner 306 in linear consumption rates 316.

According to embodiments, the calculated linear consumption rates may be extrapolated across a timeline of interest to be used to estimate consumption values anywhere along the timeline. For instance, as shown in FIG. 5, linear consumption lines 506, 508, and 510 are shown for each of the three meters, drawn through their respective initial consumption value and meter reading value points. Even though these linear consumption lines may not indicate the exact consumption values at every point (e.g., see the lack of overlap between actual consumption plot line 536 and first linear consumption line 506 for the first meter), these linear consumption lines may be used in embodiments to estimate consumption values for the meters across a timeline of interest. The timeline of interest may include times prior to or after second time 518.

Storage 304 may include one or more of any type of storage mechanism for storing information, including initial consumption values 314. For instance, storage 304 may include one or more of a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Note that although consumption rate determiner 306 is described above and elsewhere herein as determining linear consumption rates for the meters, in other embodiments, consumption rate determiner 306 may be configured to determine non-linear consumption rates for the meters. Consumption rate determiner 306 may determine non-linear consumption rates in any manner, such as determining them based on historical data or in another manner. Thus, embodiments described herein are also applicable to the determining of non-linear consumption rates, and the use of non-linear consumption rates in determining times when monetary targets are reached, determining consumption quotas, and calculating times at which monetary commitment values are reached.

Referring back to FIG. 2, in step 206, a monetary liability function is determined for the consumer based on the plurality of consumption rates and a plurality of rating functions associated with the plurality of meters. For example, as shown in FIG. 3, monetary liability function determiner 308 receives linear consumption rates 316 and a plurality of rating functions 326. Rating functions 326 includes a plurality of rating functions corresponding to the plurality of meters associated with linear consumption rates 316. The rating functions are functions configured to enable monetary costs for consumption to be determined for the consumer at different times of the timeline of interest. For instance, a rating function may be a straight line function providing a constant cost per amount of consumption, a tiered function providing multiple different constant costs per amount of consumption corresponding to different time periods (e.g., $10 per resource unit for 0-200 resource units, $8 per resource unit for 200-400 resource units, etc.), a tapered rating function providing an increasing or decreasing cost per amount of consumption over time, or other type of function or combination of functions. Monetary liability function determiner 308 is configured to determine a monetary liability function 318 for the consumer based on linear consumption rates 316 and rating functions 326.

For instance, continuing the above data service example, each of the three meters may have a corresponding rating function. For example, the three meters may have the following rating functions:

first meter: $10 per megabyte (for consumption over 100 megabytes)

second meter: $5 per megabyte (for consumption over 300 megabytes)

third meter: $15 per megabyte (for consumption over 500 megabytes)

As such, the rating functions for the first, second, and third meters are constant (non-tiered or tapered) rating functions. These rating functions are provided for purposes of illustration, and are not intended to be limiting.

Furthermore, as indicated above, the rating functions are effective for the meters for their respective overage amounts, which begin after their predetermined flat included amounts of service consumption are exhausted. For instance, as described above, the first meter has an included amount of 100 megabytes, the second meter has an included amount of 300 megabytes, and the third meter has an included amount of 500 megabytes. The rating functions indicating a cost for consumption indicated by each meter do not indicate a cost (e.g., indicate a zero cost) until the corresponding included amount of consumption is used up. For instance, FIG. 5 shows 100 megabytes for the first meter being used up at a time 514, 300 megabytes for the second meter being used up at a time 516, and 500 megabytes for the third meter being used up at a time 520.

In an embodiment, in step 206, a monetary liability function may be determined for consumption by the set of meters by generating a monetary liability function for each of the meters, and combining (e.g., summing) the resulting monetary liability functions. For instance, continuing the above example, the three monetary liability functions for the three meters may be generated as follows, by multiplying together the respective linear consumption rate, rating function, and a time “t” variable:

$$first meter \text{:} 7.5 megabytes / hour \times \$10 per megabyte \times t = 0 for time 512 to time 514 = 75 \$ ( t - t 1 ) for time 514 to time 522$$

$$second meter \text{:} 14 megabytes / hour \times \$5 per megabyte \times t = 0 for time 512 to time 516 = 70 \$ ( t - t 2 ) for time 516 to time 522$$

$$third meter \text{:} 16.67 megabytes / hour \times \$15 per megabyte \times t = 0 for time 512 to time 520 = 250.05 \$ ( t - t 3 ) for time 520 to time 522$$

where

t1=time 514,

t2=time 516, and

t3=time 520.

In this example, the three monetary liability functions for the three meters may be combined together (e.g., added together) to determine the overall monetary liability function for the three meters. For instance, monetary liability function determiner 308 may organize and combine the three monetary liability functions according to their corresponding time segments (separated by inflection points). In the current example, monetary liability function determiner 308 may combine the three monetary liability functions as shown below:

$$\begin{matrix}monetary liability function 318 = 0 for tim e 512 to time 514 \\ = 75 \$ ( t - t 1 ) for time 514 to time 516 \\ = ( 75 \$ ( t - t 1 ) + 70 \$ ( t - t 2 ) ) \\ for time 516 \text{-} time 520 \\ = ( 75 \$ ( t - t 1 ) + 70 \$ ( t - t 2 ) + \\ 250.05 \$ ( t - t3 ) ) for time 520 \text{-} time 522\end{matrix}$$

Techniques for combining multiple monetary liability functions to determine an overall monetary liability function will be known to persons skilled in the relevant art(s).

For purposes of illustration, FIG. 6 shows a plot 600 of monetary liability versus time, according to an example embodiment. Plot 600 includes a first axis 602 (an X-axis) indicating time in units of time (e.g., minutes, hours, days, etc.) and a second axis 604 (a Y-axis) indicating a monetary value of consumption (e.g., dollars or other currency). The monetary liability functions for each meter may be shown in plot 600, as well as the cumulative/overall monetary liability function for the meters. For instance, as shown in FIG. 6, monetary liability lines 606, 608, and 610 are shown for each of the three meters, based on their respective monetary liability functions determined above. Furthermore, cumulative monetary liability line 612 is shown as the sum of the three monetary liability functions of the three meters, as determined above. Points along cumulative monetary liability line 612 indicate cumulative monetary values of consumption for the three meters at particular times.

As shown in FIG. 6, cumulative monetary liability line 612 is a continuous line formed of a sequence of segments, with inflection points indicating included quantities being reached. For instance, in FIG. 5, linear consumption line 506 crosses the first axis 502 at a time 514, indicating that the corresponding included amount of consumption for the first meter (e.g., 100 megabytes) is used up at time 514. Similarly, linear consumption line 508 crosses the first axis 502 at a time 516, indicating that the included amount of consumption for the second meter (e.g., 300 megabytes) is used up at time 516, and linear consumption line 510 crosses the first axis 502 at a time 520, indicating that the included amount of consumption for the third meter (e.g., 500 megabytes) is used up at time 520. Corresponding inflection points (e.g., indicated by bends) in cumulative monetary liability line 612 at times 514, 516, and 520 are indicated in FIG. 6. It is noted that if one or more rating functions were tiered, cumulative monetary liability line 612 may have additional inflection points (that may be discontinuities) at the boundaries of the price tiers.

Referring back to FIG. 2, in step 208, a third time at which a monetary target is reached by the plurality of meters is calculated based on the monetary liability function. As shown in FIG. 3, monetary target time calculator 310 receives monetary liability function 318 and receives a monetary target value 324. Monetary target value 324 indicates a monetary value of consumption of interest. Monetary target time calculator 310 is configured to calculate a time at which the amount of consumption indicated by the set of meters reaches monetary target value 324, based on monetary liability function 318. As shown in FIG. 3, monetary target time calculator 310 generates an output time 320, which indicates the calculated third time.

For instance, in an embodiment, monetary target time calculator 310 may set monetary target value 324 equal to monetary liability function 318, and may solve the resulting equation for the variable t to determine output time 320.

For illustrative purposes, continuing the above data service example, monetary target value 324 may be received as $6000. In this example, time 514 (t1) may be 10 hours, time 516 (t2) may be 20 hours, and time 520 (t3) may be 30 hours. As such, the received monetary target value may be set equal to the monetary liability function for the three meters determined in step 206. Solving the above combined monetary liability function for the variable t results in output time 320. For instance, in this example, monetary target time calculator 310 may generate output time 320 as follows, by solving for time t:

amount at time 516=75$ (20−10)=$750
this amount is less than $6000 so we can move to the next tier.

amount at time 520=75$ (30−10)+70$(30−20)=$2200
this amount is less than $6000 so we can move to the next tier.

The next tier is the last tier, so this where the cap will be hit eventually, so the following equation may be solved:

$6000=75$(t−10)+70$(t−20)+250.05$(t−30)

Which is equivalent to:

$6000=(75$+70$+250.05$)×t−$9651.50

$15,651.50=$395.05×t

t=39.619

In this example, output time 320 is determined to be equal to 39.619 hours. Referring to FIG. 5, the time of 39.619 hours along first axis 502 is where the three meters reached consumption corresponding to the monetary target value of $6000. It is noted that output time 320 may be solved for in various ways, as would be apparent to persons skilled in the relevant art(s) from the teachings herein.

As mentioned above, the values used for the data service example are provided for purposes of illustration, and are not intended to be limiting.

Accordingly, reverse rating system 300 of FIG. 3 and/or flowchart 200 of FIG. 2 may be used to determine monetary target values of consumption by a set of meters based on estimated linear consumption rates. Such a determination may be useful in various situations, such as in applications of monetary cap enforcement, monetary commitment situations, combinations thereof, and further situations. The following subsections describe example embodiments for reverse rating applied to monetary cap enforcement and monetary commitment situations.

A. Example Monetary Cap Enforcement Embodiments

In embodiments, reverse rating may be applied to monetary cap enforcement.

Such an embodiment may enable consumers to limit their financial liability for overage in the form of a capped monetary amount per billing cycle. In embodiments, reverse rating may be applied in various ways to enforce such a cap, preventing the monetary value of consumption by a consumer to exceed the monetary cap.

For instance, in an embodiment, at the beginning of a billing cycle, and based on a consumption rate (from a previous billing cycle or an arbitrary default) and a monetary cap, reverse rating may be used to estimate an amount of consumption by a set of meters that would trigger the monetary cap being met. This estimate may be used to calculate a consumption quota for each meter. Subsequently, the meters are monitored to determine whether a quota is hit. Whether a quota is hit may be detected, even at scale, by maintaining the determined quotas in association with the total consumption since the beginning of the billing cycle. The overall monetary cap is not hit until at least one of the determined quotas is hit, and no further rating operations are needed to be performed until at least one of the determined quotas is hit (saving a number of calculations relative to conventional techniques). When a quota is hit by a meter, either the monetary cap is also hit (which may trigger an action, such as suspending service, sending a warning message to the consumer, etc.) or the monetary cap is not yet hit, and a new set of quotas may be determined for the set of meters using techniques of reverse rating. This process may be repeated until the billing cycle ends, at which time the process may begin again.

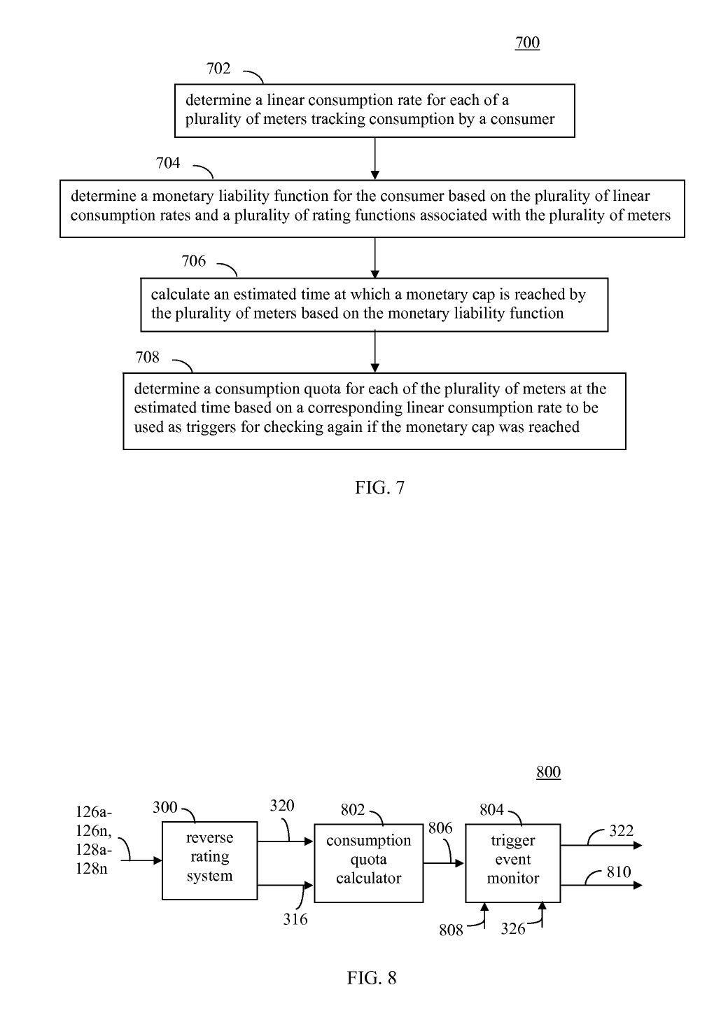

A reverse rating system may be configured in various ways to perform monetary cap enforcement, in embodiments. For instance, FIG. 7 shows flowchart 700 providing a process for using reverse rating with regard to a set of meters having an associated monetary cap, according to an example embodiment. In an embodiment, reverse rating system 108 may operate according to flowchart 700. For purposes of illustration, flowchart 700 of FIG. 7 is described with respect to FIG. 8. FIG. 8 shows a block diagram of a monetary cap monitoring system 800 configured for a set of meters having an associated monetary cap, according to an example embodiment. As shown in FIG. 8, monetary cap monitoring system 800 includes reverse rating system 300 (of FIG. 3), a consumption quota calculator 802, and a trigger event monitor 804. Flowchart 700 and monetary cap monitoring system 800 are described as follows, with some reference to reverse rating system 300 of FIG. 3. Further structural and operational embodiments will be apparent to persons skilled in the relevant art(s) based on the following description.

Flowchart 700 begins with step 702. In step 702, a linear consumption rate is determined for each of a plurality of meters tracking consumption by a consumer. For instance, in one embodiment, at the beginning of a billing cycle, a linear consumption rate may be retrieved from storage (e.g., storage 304 of FIG. 3) for each meter as a predetermined stored linear consumption rate. Such a predetermined stored linear consumption rates may have been determined automatically (e.g., based on history associated with the consumer, with other consumers, and/or with the meters), may have been set by a human (e.g., by an administrator of system 800, etc.), or may have been determined in another way. In another embodiment, the linear consumption rate for each meter may be calculated based on an immediately prior billing cycle, or other previous billing cycle, for the consumer. The linear consumption rate for prior billing cycles may have been determined in a similar manner as described with regard to steps 202 and 204 of flowchart 200 (FIG. 2) and consumption rate determiner 306 (FIG. 3), or in another manner.

In step 704, a monetary liability function is determined for the consumer based on the plurality of linear consumption rates and a plurality of rating functions associated with the plurality of meters. For instance, in an embodiment, as shown in FIG. 3, monetary liability function determiner 308 receives linear consumption rates 316 and a plurality of rating functions 326. Rating functions 326 includes a plurality of rating functions corresponding to the plurality of meters associated with linear consumption rates 316. Monetary liability function determiner 308 may determine monetary liability function 318 for the consumer based on linear consumption rates 316 and rating functions 326 in a manner as described above, such as with reference to step 206 of flowchart 200 (FIG. 2).

As described above, FIG. 6 shows an example of a plotted monetary liability function 318 as cumulative monetary liability line 612, representing the monetary liability over time for three meters in the data service example.

In step 706, an estimated time is calculated at which a monetary cap is reached by the plurality of meters based on the monetary liability function. For instance, as shown in FIG. 3, monetary target time calculator 310 receives monetary liability function 318 and receives a monetary target value 324. As described above, monetary target value 324 indicates a monetary value of consumption of interest. In a monetary cap enforcement embodiment, monetary target value 324 may be a monetary cap for a consumer for a set of meters. As described above (e.g., with respect to step 208 in FIG. 2), monetary target time calculator 310 is configured to calculate a time at which the amount of consumption indicated by the set of meters reaches monetary target value 324, based on monetary liability function 318. As shown in FIG. 3, monetary target time calculator 310 generates an output time 320, which indicates the calculated third time. In a monetary cap enforcement embodiment, output time 320 indicates an estimated time at which the set of meters will measure an amount of consumption that has a monetary value of the monetary cap.

Referring to FIG. 6 with regard to the data service example, monetary cap line 614 may indicate a monetary value for a cap. In this example, monetary target time calculator 310 may calculate third time 522 to be the time at which the monetary cap value is reached by the three meters (as shown in FIG. 6, cumulative monetary liability line 612 intersects with monetary cap line 614 at third time 522).

In an embodiment, the consumer may optionally be provided with the estimated time as a projected time at which the monetary cap is reached by the consumer. In this manner, the consumer may be able to change its consumption rates (e.g., increasing or decreasing) associated with one or more of the meters, if needed.

Referring back to FIG. 7, in step 708, a consumption quota is determined for each of the plurality of meters at the estimated time based on a corresponding linear consumption rate to be used as triggers for checking again if the monetary cap was reached. For instance, as shown in FIG. 8, consumption quota calculator 802 receives linear consumption rates 316 and output time 320. Based on linear consumption rates 316 and output time 320, consumption quota calculator 802 is configured to determine a consumption quota for each meter of the set of meters. The consumption quotas may be used as triggers for determining whether the monetary cap has been reached by the consumer consuming the services being monitored the set of meters. As shown in FIG. 8, consumption quota calculator 802 generates consumption quotas 806, which includes a consumption quota calculated for each meter of the set of meters.

For instance, in an embodiment, a consumption quota may be determined for a meter by consumption quota calculator 802 by subtracting the inflection time point (the time when the included consumption amount for the meter is reached) from output time 320, and multiplying the corresponding linear consumption rate by the result. Consumption quota calculator 802 may perform this calculation for each meter of the set of meters to generate consumption quotas 806.

For example, if monetary cap enforcement is applied to the three meters in the data service example, and assuming that output time 320 is 39.619 hours, consumption quotas may be generated for the three meters as follows:

first meter: 7.5 megabytes/hour×(39.619−10) hours=222.1425 megabytes

second meter: 14 megabytes/hour×(39.619−20) hours=274.666 megabytes

third meter: 16.67 megabytes/hour×(39.619−30) hours=160.34873 megabytes

In this example, consumption quota calculator 802 may output these three consumption quotas for the three meters in consumption quotas 806.

As shown in FIG. 8, trigger event monitor 804 may receive consumption quotas 806. Trigger event monitor 804 may be configured to determine the occurrence of one or more types of trigger events that indicate that the monetary cap may have been reached. For instance, trigger event monitor 804 may monitor whether any meter of the set of meters has reached its corresponding consumption quota. If a meter has reached its corresponding quota, the monetary cap may possibly have been reached by the set of meters. If the monetary cap has been determined to be reached, one or more actions may be performed, such as trigger event monitor 804 generating an action signal 810 that suspends one or more services associated with the plurality of meters with the consumer, alerts the consumer that the monetary cap has been reached, and/or performs other action. If the monetary cap has been determined to not have been reached, the latest consumption measurements may be used to restart the process.

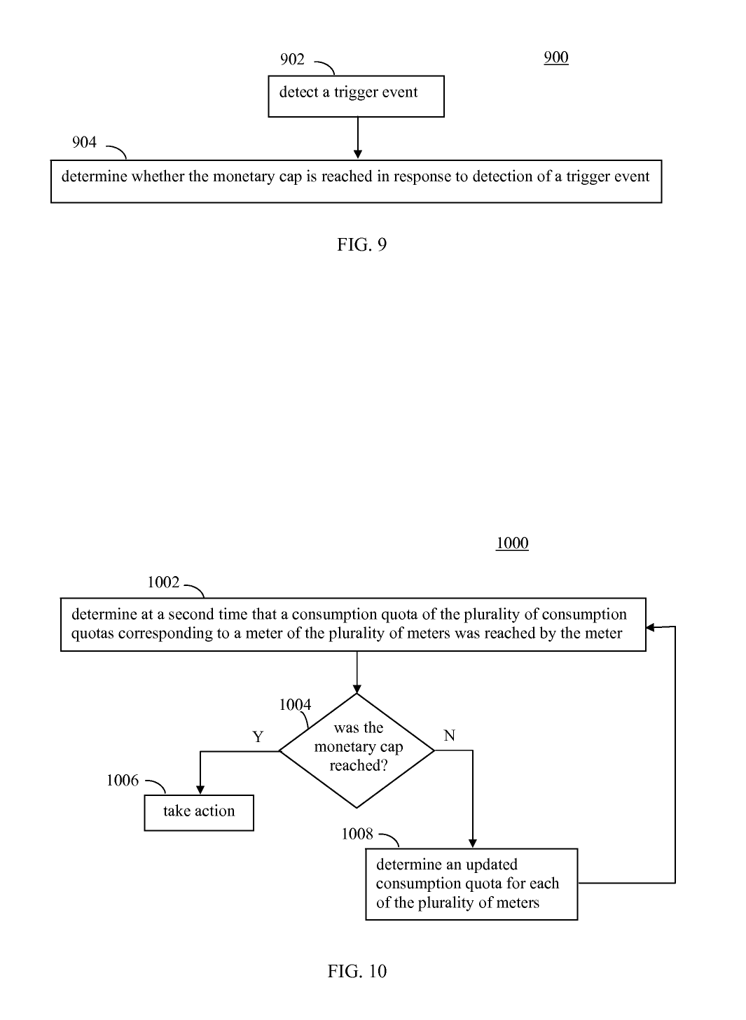

For instance, in an embodiment, trigger event monitor 804 may operate according to FIG. 9. FIG. 9 shows a flowchart 900 providing a process for monitoring whether a monetary cap is reached, according to an example embodiment. Flowchart 900 is described as follows. Further structural and operational embodiments will be apparent to persons skilled in the relevant art(s) based on the following description.

In step 902, a trigger event is detected. For example, as shown in FIG. 8, trigger event monitor 804 may receive consumption information 808 at a time (a second time) that is subsequent to a time (a first time) associated with the prior calculation of the consumption quotas. Consumption information 808 may indicate consumption information by the set of meters (e.g., may include meter readings 126a-126n and 128a-128n associated with the set of meters) at the second time. Trigger event monitor 804 may analyze consumption information 808 to determine whether a trigger event has occurred, such as by consumption indicated by one or more meters having reached a consumption quota or having reached other consumption amount considered to be a trigger.

In step 904, whether the monetary cap is reached is determined in response to detection of a trigger event. In an embodiment, if trigger event monitor 804 determines in step 902 that a trigger event occurred, trigger event monitor 804 may perform a determination of whether the monetary cap has been reached. If the monetary cap has been determined to be reached, appropriate action may be taken.

FIG. 10 shows a flowchart 1000 providing a more detailed process for flowchart 900 of FIG. 9, according to an example embodiment. In an embodiment, trigger event monitor 804 may operate according to flowchart 1000. Flowchart 1000 is described as follows. Further structural and operational embodiments will be apparent to persons skilled in the relevant art(s) based on the following description.

Flowchart 1000 starts with step 1002. In step 1002, it is determined that, at a second time, a consumption quota of the plurality of consumption quotas corresponding to a meter of the plurality of meters was reached by the meter. For example, in an embodiment, trigger event monitor 804 may receive consumption information 808 (e.g., from consumption aggregator 118 of FIG. 1), which may include meter readings 126a-126n and 128a-128n associated with the set of meters captured at the second time. For instance, in an embodiment, trigger event monitor 804 may be located near or in meters 106a-106n (FIG. 1), of the set of meters, to efficiently receive meter readings 126a-126n. Alternatively, trigger event monitor 804 may be located remotely from the set of meters.

It is noted that in an embodiment, consumption information 808 may include a tuple for each meter, the tuple including [total consumption since the beginning of the cycle, quota determined by quota calculator] (consumption aggregator 118 may store quotas, in an embodiment). When a consumption event (a consumption message) is received, the amount of consumption is added to the total and is compared with the quota by consumption aggregator 118. If the quota is exceeded, consumption aggregator 118 may “publish” a quota exceeded message for the given subscription. Another entity (trigger event monitor 804) may “subscribe” to the published message, receive events, and take appropriate action as described herein.

Thus, in one embodiment, trigger event monitor 804 may compare each meter reading to the consumption quota of the corresponding meter. If a meter reading of at least one meter has reached the corresponding consumption quota, trigger event monitor 804 has detected a trigger event. In another embodiment, this comparison and determination of whether a trigger event has occurred may be performed by consumption aggregator 118. In such an embodiment, consumption aggregator 118 may generate a trigger event message (e.g., a quota exceeded message) that is received by trigger event monitor 804. Operation proceeds from step 1002 to step 1004.

In step 1004, it is determined whether the monetary cap has been reached. In an embodiment, when trigger event monitor 804 determines that a meter reading for a meter of the set of meters has reached the corresponding consumption quota for the meter, trigger event monitor 804 is configured to determine whether the monetary cap has been reached. In an embodiment, to determine whether the monetary cap has been reached, trigger event monitor 804 calculates a current monetary value of consumption. For instance, trigger event monitor 804 may receive rating functions 326, which includes a plurality of rating functions corresponding to the plurality of meters, and are functions configured to enable monetary costs for consumption to be determined for the consumer at different times of the timeline of interest. Trigger event monitor 804 may, for each meter, may apply the corresponding rating function to the current consumption amount (e.g., from meter readings 126a-126n and 128a-128n), and may sum the resulting amounts to calculate the current monetary value of consumption. Trigger event monitor 804 may compare the calculated current monetary value of consumption to the monetary cap to determine whether the monetary cap has been reached.

If the monetary cap is determined to be reached, operation proceeds from step 1004 to step 1006. If the monetary cap is determined to not have been reached, operation proceeds from step 1004 to step 1008.

In step 1006, action is taken. For instance, because trigger event monitor 804 determined the monetary cap to be reached, trigger event monitor 804 may perform one or more actions, such as generating action signal 810, as described above. Operation of flowchart 1000 may be complete after step 1006 is performed if the subscription/service is stopped.

In step 1008, an updated consumption quota is determined for each of the plurality of meters. For instance, because trigger event monitor 804 determined the monetary cap to not be reached, trigger event monitor 804 may generate an update consumption quotas instruction 812. Update consumption quotas instruction 812 is an instruction to determine updated consumption quotas for the set of meters that may subsequently be used as triggers to determine whether the monetary cap has been reached. When the updated consumption quotas are determined, operation may proceed from step 1008 back to step 1002.

For instance, as shown in FIG. 8, update consumption quotas instruction 812 may be received by reverse rating system 300. In response, reverse rating system 300 may re-perform steps 702, 704, and 706 of flowchart 700 (FIG. 7), and consumption quota calculator 802 may re-perform step 708 of flowchart 700 to calculate the updated consumption quotas for the set of meters.

For example, when update consumption quotas instruction 812 is received, consumption readings associated with the second time may be received from meters 106a-106n by meter reader 302, as shown in FIG. 3. Meter reader 302 may output the meter readings as consumption readings 312. Consumption rate determiner 306 may receive consumption readings 312 and initial consumption values 314, and may determine an updated linear consumption rate for each of the meters based thereon. Consumption rate determiner 306 may generate linear consumption rates 316 to include the updated linear consumption rates of the set of meters. Monetary liability function determiner 308 may receive linear consumption rates 316 and rating functions 326, and may generate an updated monetary liability function based thereon. Monetary liability function determiner 308 may generate monetary liability function 318 to include the updated monetary liability function. Monetary target time calculator 310 may receive monetary liability function 318 and monetary target value 324 (the monetary cap). Monetary target time calculator 310 may calculate an updated estimated time at which the monetary cap is reached by the plurality of meters based on thereon. Monetary target time calculator 310 may output the updated estimated time as output time 320. Referring to FIG. 8, consumption quota calculator 802 may receive output time 320 and linear consumption rates 316, and may calculate an updated consumption quota for each of the meters at the updated estimated time based thereon. Consumption quota calculator 802 may output the updated consumption quotas as consumption quota 806

As shown in FIG. 8, trigger event monitor 804 may receive the updated consumption quotas in consumption quotas 806, and may re-perform flowchart 1000 of FIG. 10. For instance, trigger event monitor 804 may monitor consumption as indicated by the set of meters for another trigger event, such as in step 1002 of flowchart 1000, where a meter consumption level for a meter reaches the corresponding consumption quota.

B. Example Monetary Commitment Situation Embodiments

In embodiments, reverse rating may be applied to monetary commitment situations. In a monetary commitment situation, a consumer commits/agrees to pay a flat monetary commitment value/amount for a service or set of services that the consumer will use/consume over a billing period. For consumption having a monetary consumption value below and up to the flat monetary commitment amount, the consumer receives a monetary discount (e.g., a percentage discount relative to standard rates) on the consumption. For consumption above the flat monetary commitment amount, the consumer pays standard, non-discounted rates on the consumption.

Embodiments may use reverse rating to determine amounts that a consumer is billed in a monetary commitment situation. Reverse rating may be used to determine a discount on their consumption up to the amount they commit to paying. Further consumption may be rated at the standard, non-discounted, retail rates. For instance, reverse rating may be applied to past time periods during a billing cycle or period (assuming the consumer did not commit to pay more than they actually consumed during the billing period). For a determined amount of consumption at the end of a billing cycle, a discounted rating function, and the monetary commitment value, reverse rating may be used to determine when the monetary commitment value was reached during the billing cycle and the corresponding consumption at that time. The rest of the consumption during that billing cycle may be rated using a standard, retail rating function.

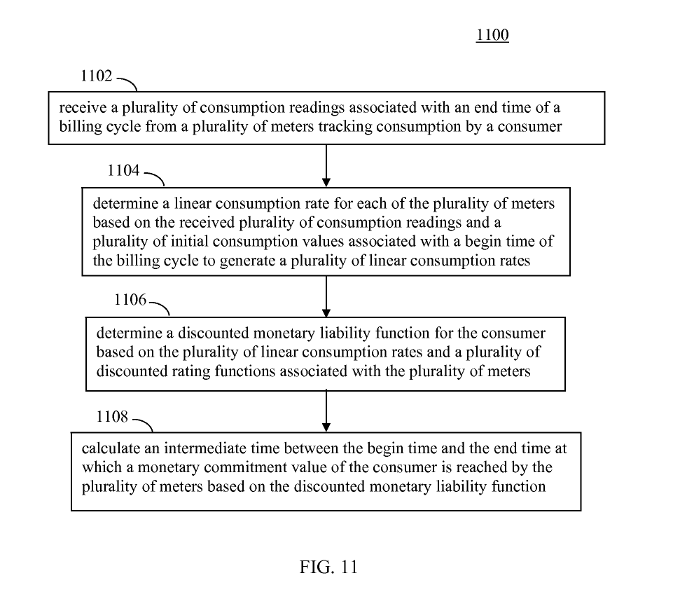

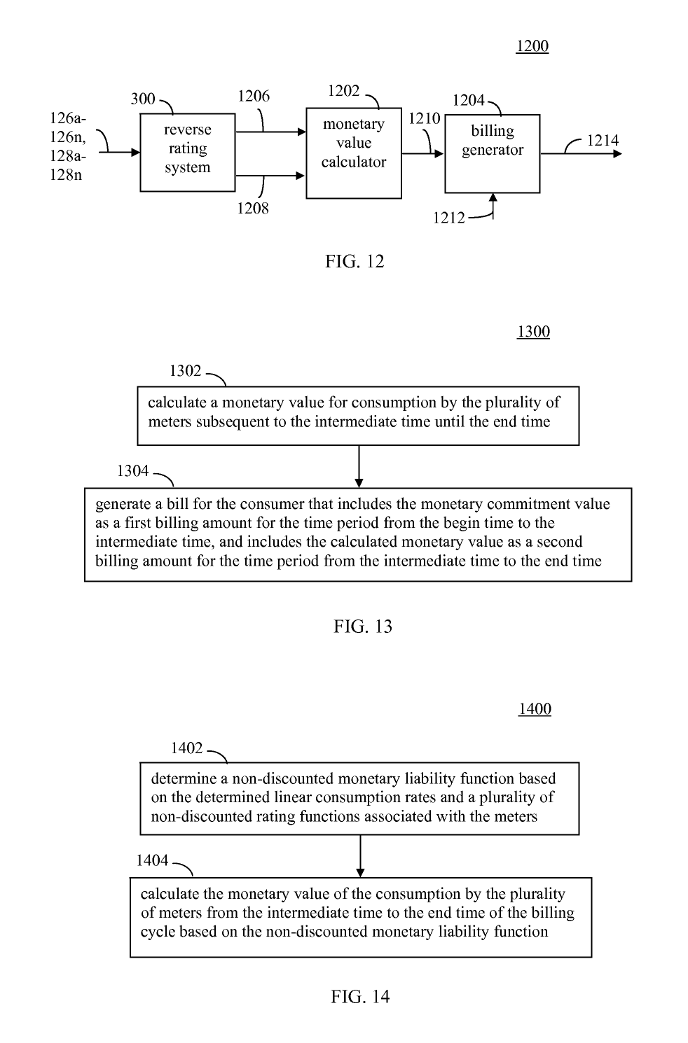

A reverse rating system may be configured in various ways to handle a monetary commitment value, in embodiments. For instance, FIG. 11 shows flowchart 1100 providing a process for using reverse rating with regard to a set of meters having an associated monetary commitment value, according to an example embodiment. In an embodiment, reverse rating system 108 may operate according to flowchart 1100. For purposes of illustration, flowchart 1100 of FIG. 11 is described with respect to FIG. 12. FIG. 12 shows a block diagram of a monetary commitment enforcement system 1200 configured for a set of meters having an associated monetary commitment value 1212, according to an example embodiment. As shown in FIG. 12, monetary commitment enforcement system 800 includes reverse rating system 300 (of FIG. 3), a monetary value calculator 1202, and a bill generator 1204. Flowchart 1100 and monetary commitment enforcement system 1200 are described as follows, with some reference to reverse rating system 300 of FIG. 3. Further structural and operational embodiments will be apparent to persons skilled in the relevant art(s) based on the following description.

Flowchart 1100 begins with step 1102. In step 1102, a plurality of consumption readings associated with an end time of a billing cycle is received from a plurality of meters tracking consumption by a consumer. For example, as shown in FIG. 12, reverse rating system 300 receives meter readings 126a-126n and 128a-128n. As described above, meter readings 126a-126n and 128a-128n are consumption readings received from corresponding meters that indicate consumption by a consumer (e.g., including first and second meter readings 112a and 112b from first and second meters 106a and 106b shown in FIG. 1). Meter readings 126a-126n and 128a-128n may be consumption readings indicating consumption by a consumer at the end time of a billing cycle (e.g., a current billing cycle). Referring to FIG. 3, meter reader 302 outputs consumption readings 312, which include the received meter readings in a processed or non-processed form. Furthermore, consumption rate determiner 306 receives consumption readings 312.

In step 1104, a linear consumption rate for each of the plurality of meters is determined based on the received plurality of consumption readings and a plurality of initial consumption values associated with a begin time of the billing cycle to generate a plurality of linear consumption rates. For example, as described above with respect to FIG. 3, consumption rate determiner 306 receives consumption readings 312 and initial consumption values 314. Initial consumption values 314 includes a plurality of initial consumption values associated with the meters corresponding to consumption readings 312. Initial consumption values 314 may be meter readings taken previously at the begin time of the billing cycle. Typically, because totals are generated per billing cycle, initial consumption values 314 are zero values (because each cycle starts at zero). If included quantities are present for the meters, the included quantities may be considered to be initial consumption values 314 (indicated as negative consumption values).

Based on consumption readings 312 and initial consumption values 314, consumption rate determiner 306 generates a plurality of linear consumption rates 316, which includes a linear consumption rate determined for each meter. For instance, consumption rate determiner 306 may generate linear consumption rates 316 as described above (e.g., with respect to FIG. 4) or in another manner.

For instance, with respect to the three meter example of FIG. 5, the begin time of the billing cycle may be first time 512, and the end time of the billing cycle may be third time 522. First-third initial values 524, 526, and 528 may be the initial consumption values indicated by the three meters at the begin time (first time 512), and first-third meter reading values 538, 540, and 542 may be meter readings taken at the end time of the billing cycle (e.g., third time 522) indicating final consumption values for the three meters. In a manner as described further above, consumption rate determiner 306 may generate linear consumption rates for the three meters based on these three initial consumption values and three final consumption values. These generated linear consumption rates are graphically shown as linear consumption lines 506, 508, and 510 in FIG. 5.

Referring back to FIG. 11, in step 1106, a discounted monetary liability function is determined for the consumer based on the plurality of linear consumption rates and a plurality of discounted rating functions associated with the plurality of meters. For instance, in an embodiment, as shown in FIG. 3, monetary liability function determiner 308 receives linear consumption rates 316 and a plurality of rating functions 326. Rating functions 326 includes a plurality of rating functions corresponding to the plurality of meters associated with linear consumption rates 316. In the current embodiment, for a monetary commitment situation, rating functions 326 may be discounted rating functions. The discounted rating functions indicate discounted monetary liability rates for consumption during the time period from the beginning of the billing cycle until the monetary commitment value is met (after which standard rating functions apply). Monetary liability function determiner 308 may determine monetary liability function 318 as a discounted monetary liability function 318 for the consumer based on linear consumption rates 316 and the discounted rating functions 326 in a manner as described above, such as with reference to step 206 of flowchart 200 (FIG. 2).

In step 1108, an intermediate time between the begin time and the end time is calculated at which a monetary commitment value of the consumer is reached by the plurality of meters based on the discounted monetary liability function. For instance, as shown in FIG. 3, monetary target time calculator 310 receives the discounted monetary liability function 318 and receives a monetary target value 324. As described above, monetary target value 324 indicates a monetary commitment value for the consumer. As described above (e.g., with respect to step 208 in FIG. 2), monetary target time calculator 310 is configured to calculate a time at which the amount of consumption indicated by the set of meters reaches monetary target value 324, based on monetary liability function 318. In the current embodiment, monetary target time calculator 310 may calculate a time at which the amount of consumption indicated by the set of meters reaches the monetary commitment value based on the discounted monetary liability function 318. As shown in FIG. 3, monetary target time calculator 310 generates an output time 320, which indicates the calculated intermediate time between the begin and end times. In a monetary commitment embodiment, output time 320 indicates an estimated time at which the set of meters measured an amount of consumption (at the discounted rates) that had a monetary value of the monetary commitment value.

For instance, referring to FIG. 5 with regard to the data service example, second time 518 may be the calculated intermediate time (between the begin time of first time 512 and the end time of third time 522) where a monetary commitment value is estimated to have been reached.

In an embodiment, the consumer may optionally be provided with the calculated intermediate time as a time at which the monetary commitment value was estimated to have been reached by consumption by the consumer. In this manner, the consumer is provided some information as to how the bill for the billing period is generated (discounted rates applied before the intermediate time; standard rates applied after the intermediate time). Furthermore, the consumer may be able to change its consumption rates (e.g., increasing or decreasing) associated with one or more of the meters, if needed, for future billing periods. Furthermore, the amount of consumption at the intermediate time may be determined for each meter by multiplying the determined intermediate time by the corresponding linear consumption rate (the included amount may be subtracted from the result if desired to only show the amount of consumption over the included amount).

Accordingly, using the calculated intermediate time, a bill that indicates a monetary value of consumption over the billing cycle by the consumer may be generated. The monetary commitment value may be used for the bill portion for the begin time to the intermediate time and a non-discounted monetary liability function may be used to determine the bill portion subsequent to the intermediate time until the end time.

For instance, FIG. 13 shows a flowchart 1300 providing a process for generating a bill with regard to a monetary commitment value situation, according to an example embodiment. In an embodiment, monetary commitment enforcement system 1200 of FIG. 12 may operate according to flowchart 1300. Further structural and operational embodiments will be apparent to persons skilled in the relevant art(s) based on the following description regarding flowchart 1300.

Flowchart 1300 begins with step 1302. In step 1302, a monetary value is calculated for consumption by the plurality of meters subsequent to the intermediate time until the end time. For instance, in an embodiment, as shown in FIG. 12, monetary value calculator 1202 receives intermediate time 1206, which may be output time 320 generated in step 1108. Furthermore, monetary value calculator 1202 may receive a non-discounted monetary liability function 1208 generated by monetary liability function determiner 308 in a similar manner as the discounted monetary liability function 318 is generated. Based on these inputs, monetary value calculator 1202 generates a monetary consumption value 1210, which indicates a monetary value of the consumption by the set of meters after intermediate time 1206 until the end time for the billing cycle.

For instance, in an embodiment, monetary consumption value 1210 may be generated according to FIG. 14. FIG. 14 shows a flowchart 1400 providing a process for determining a monetary value of consumption by a plurality of meters for consumption above the associated monetary commitment value, according to an example embodiment. Further structural and operational embodiments will be apparent to persons skilled in the relevant art(s) based on the following description regarding flowchart 1400.

In step 1402, a non-discounted monetary liability function is determined based on the determined linear consumption rates and a plurality of non-discounted rating functions associated with the meters. For instance, in an embodiment, as shown in FIG. 3, monetary liability function determiner 308 receives linear consumption rates 316 (determined according to step 1104 of FIG. 11) and a plurality of rating functions 326. In this case, rating functions 326 rating functions 326 are standard, retail rating functions for the meters. These standard, non-discounted rating functions indicate standard monetary liability rates for consumption during the time period from the time the monetary commitment value is met until the end of the billing cycle. Monetary liability function determiner 308 may determine monetary liability function 318 as a non-discounted monetary liability function 318 for the consumer based on linear consumption rates 316 and the non-discounted rating functions 326 in a manner as described above, such as with reference to step 206 of flowchart 200 (FIG. 2).

In step 1404, the monetary value of the consumption by the plurality of meters from the intermediate time to the end time of the billing cycle is calculated based on the non-discounted monetary liability function. As shown in FIG. 12, monetary value calculator 1202 receives intermediate time 1206 and non-discounted monetary liability function 1208 (generated by monetary liability function determiner 308 in step 1402). To calculate monetary consumption value 1210, monetary value calculator 1202 may input intermediate time 1206 as the time variable to non-discounted monetary liability function 1208 to determine a non-discounted monetary value of consumption at intermediate time 1206. Furthermore, monetary value calculator 1202 may input the end time of the billing cycle as the time variable to non-discounted monetary liability function 1208 to determine a non-discounted monetary value of consumption at the end time of the billing cycle. Monetary value calculator 1202 may subtract the non-discounted monetary value of consumption at intermediate time 1206 from the non-discounted monetary value of consumption at the end time of the billing cycle to generate monetary consumption value 1210. As described above, monetary consumption value 1210 indicates a monetary value of the consumption by the set of meters for the time period from intermediate time 1206 until the end time for the billing cycle.

Referring back to FIG. 13, in step 1304, a bill for the consumer that includes the monetary commitment value as a first billing amount for the time period from the begin time to the intermediate time, and includes the calculated monetary value as a second billing amount for the time period from the intermediate time to the end time. For example, as shown in FIG. 12, bill generator 1204 may receive monetary commitment value 1212 (which is the monetary commitment value also received as monetary target value 324 in FIG. 3, as described above) and monetary consumption value 1210. Bill generator 1204 generates an invoice or bill 1214 for the consumer that indicates monetary commitment value 1212 as a first billing amount for the billing cycle (from the begin time to intermediate time 1206) and indicates monetary consumption value 1210 as a second billing amount for the billing cycle (from intermediate time 1206 until the end time).

Bill generator 1204 may generate bill 1214 in any manner, including as an electronic document (e.g., delivered via email, etc.), as a paper document, or in other form.

Note that it is possible that in a monetary commitment situation, the consumer may over commit, such that the time calculated in step 1108 (output time 320) is actually after the end time (the monetary commitment value is not reached during the billing cycle). In such situations, the consumer may decide to lower their monetary commitment value, particularly if this situation is chronic over time. This over commitment may average out over time (due to consumption varying from month-to-month). In an embodiment, the excess amount of the commitment may be rolled over into the following billing cycle.

C. Further Embodiments for Reverse Rating

It is noted that in embodiments, reverse rating may be used in further applications, as would be apparent to persons skilled in the relevant art(s), as well as in combinations of applications, including those applications described herein. For instance, reverse rating may be used in a metering system that uses both a monetary cap and a monetary commitment value. In such an embodiment, each reverse rating operation that occurs as part of the monetary cap detection (e.g., as described with respect to FIGS. 7-10) may again use reverse rating to detect the time at which a switch from a discounted rate to a standard rate on consumption occurs (e.g., as described with respect to FIGS. 11-14), which may be another inflection point (or discontinuity) in the rating function.

### III. Example Computing Device Embodiments

Reverse rating system 108, consumption aggregator 118, reverse rating system 300, meter reader 302, consumption rate determiner 306, monetary liability function determiner 308, monetary target time calculator 310, monetary commitment enforcement system 800, consumption quota calculator 802, trigger event monitor 804, monetary commitment enforcement system 1200, monetary value calculator 1202, billing generator 1204, flowchart 200, flowchart 400, flowchart 700, flowchart 900, flowchart 1000, flowchart 1100, flowchart 1300, and flowchart 1400 may be implemented in hardware, or hardware and any combination of software and/or firmware. For example, reverse rating system 108, consumption aggregator 118, reverse rating system 300, meter reader 302, consumption rate determiner 306, monetary liability function determiner 308, monetary target time calculator 310, monetary commitment enforcement system 800, consumption quota calculator 802, trigger event monitor 804, monetary commitment enforcement system 1200, monetary value calculator 1202, billing generator 1204, flowchart 200, flowchart 400, flowchart 700, flowchart 900, flowchart 1000, flowchart 1100, flowchart 1300, and/or flowchart 1400 may be implemented as computer program code configured to be executed in one or more processors and stored in a computer readable storage medium. Alternatively, reverse rating system 108, consumption aggregator 118, reverse rating system 300, meter reader 302, consumption rate determiner 306, monetary liability function determiner 308, monetary target time calculator 310, monetary commitment enforcement system 800, consumption quota calculator 802, trigger event monitor 804, monetary commitment enforcement system 1200, monetary value calculator 1202, billing generator 1204, flowchart 200, flowchart 400, flowchart 700, flowchart 900, flowchart 1000, flowchart 1100, flowchart 1300, and/or flowchart 1400 may be implemented as hardware logic/electrical circuitry.

For instance, in an embodiment, one or more of reverse rating system 108, consumption aggregator 118, reverse rating system 300, meter reader 302, consumption rate determiner 306, monetary liability function determiner 308, monetary target time calculator 310, monetary commitment enforcement system 800, consumption quota calculator 802, trigger event monitor 804, monetary commitment enforcement system 1200, monetary value calculator 1202, billing generator 1204, flowchart 200, flowchart 400, flowchart 700, flowchart 900, flowchart 1000, flowchart 1100, flowchart 1300, and/or flowchart 1400 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

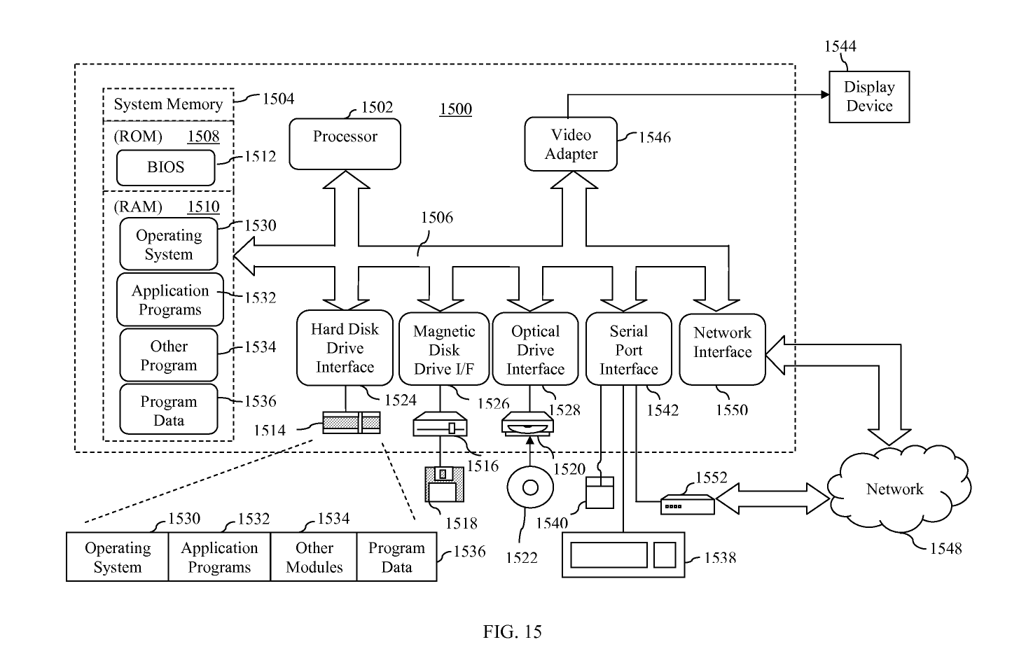

FIG. 15 depicts an exemplary implementation of a computer 1500 in which embodiments of the present invention may be implemented. For example, vendor system 102, reverse rating system 108, reverse rating system 300, monetary commitment enforcement system 800, and/or monetary commitment enforcement system 1200 may be implemented in one or more computer systems similar to computer 1500, including one or more features of computer 1500 and/or alternative features. The description of computer 1500 provided herein is provided for purposes of illustration, and is not intended to be limiting. Embodiments of the present invention may be implemented in further types of computer systems, as would be known to persons skilled in the relevant art(s).

As shown in FIG. 15, computer 1500 includes one or more processors 1502, a system memory 1504, and a bus 1506 that couples various system components including system memory 1504 to processor 1502. Bus 1506 represents one or more of any of several types of bus structures, including a memory bus or memory controller, a peripheral bus, an accelerated graphics port, and a processor or local bus using any of a variety of bus architectures. System memory 1504 includes read only memory (ROM) 1508 and random access memory (RAM) 1510. A basic input/output system 1512 (BIOS) is stored in ROM 1508.

Computer 1500 also has one or more of the following drives: a hard disk drive 1514 for reading from and writing to a hard disk, a magnetic disk drive 1516 for reading from or writing to a removable magnetic disk 1518, and an optical disk drive 1520 for reading from or writing to a removable optical disk 1522 such as a CD ROM, DVD ROM, or other optical media. Hard disk drive 1514, magnetic disk drive 1516, and optical disk drive 1520 are connected to bus 1506 by a hard disk drive interface 1524, a magnetic disk drive interface 1526, and an optical drive interface 1528, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1530, one or more application programs 1532, other program modules 1534, and program data 1536. Application programs 1532 or program modules 1534 may include, for example, computer program logic (e.g., computer program code or instructions) for implementing reverse rating system 108, consumption aggregator 118, reverse rating system 300, meter reader 302, consumption rate determiner 306, monetary liability function determiner 308, monetary target time calculator 310, monetary commitment enforcement system 800, consumption quota calculator 802, trigger event monitor 804, monetary commitment enforcement system 1200, monetary value calculator 1202, billing generator 1204, flowchart 200, flowchart 400, flowchart 700, flowchart 900, flowchart 1000, flowchart 1100, flowchart 1300, and/or flowchart 1400 (including any step of flowcharts 200, 400, 700, 900, 1000, 1100, 1300, and 1400), and/or further embodiments described herein.

A user may enter commands and information into the computer 1500 through input devices such as keyboard 1538 and pointing device 1540. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1502 through a serial port interface 1542 that is coupled to bus 1506, but may be connected by other interfaces, such as a parallel port, game port, or a universal serial bus (USB).

A display component 1544 is also connected to bus 1506 via an interface, such as a video adapter 1546. In addition to the monitor, computer 1500 may include other peripheral output devices (not shown) such as speakers and printers.

Computer 1500 is connected to a network 1548 (e.g., the Internet) through an adaptor or network interface 1550, a modem 1552, or other means for establishing communications over the network. Modem 1552, which may be internal or external, may be connected to bus 1506 via serial port interface 1542, as shown in FIG. 15, or may be connected to bus 1506 using another interface type, including a parallel interface.

As used herein, the terms “computer program medium,” “computer-readable medium,” and “computer-readable storage medium” are used to generally refer to media such as the hard disk associated with hard disk drive 1514, removable magnetic disk 1518, removable optical disk 1522, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1532 and other program modules 1534) may be stored on the hard disk, magnetic disk, optical disk, ROM, or RAM. Such computer programs may also be received via network interface 1550, serial port interface 1542, or any other interface type. Such computer programs, when executed or loaded by an application, enable computer 1500 to implement features of embodiments of the present invention discussed herein. Accordingly, such computer programs represent controllers of the computer 1500.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
receiving a plurality of consumption readings associated with a second time from a plurality of meters tracking consumption by a consumer;
determining a consumption rate for each of the plurality of meters based on the received plurality of consumption readings and a plurality of initial consumption values associated with a first time prior to the second time to generate a plurality of consumption rates;
determining a monetary liability function for the consumer based on the plurality of consumption rates and a plurality of rating functions associated with the plurality of meters; and
calculating a third time at which a monetary target is reached by the plurality of meters based on the monetary liability function.

2. The method of claim 1, further comprising:
determining that a trigger point is reached at the second time; and
retrieving the plurality of consumption readings from the meters in response to said determining that the trigger point is reached.

3. The method of claim 1, wherein said determining a consumption rate for each of the plurality of meters to generate a plurality of consumption rates comprises:
generating a linear consumption rate for each meter by
determining a difference between one of the received consumption readings corresponding to the meter and one of the initial consumption values corresponding to the meter, and
dividing the determined difference over a difference between the second time and the first time.

4. The method of claim 1, wherein at least one meter of the plurality of meters tracks consumption of data from a data source, wherein said receiving comprises:
receiving an indication of an amount of data consumed of the data service at the second time from the at least one meter.

5. The method of claim 1, further comprising:
providing the consumer with the calculated third time.

6. The method of claim 1, wherein the monetary target is a monetary cap associated with a monetary amount of consumption by the plurality of meters, wherein calculating a third time at which a monetary target is reached by the plurality of meters based on the monetary liability function comprises:
determining the third time to be an estimated time at which the monetary cap is reached by the plurality of meters.

7. The method of claim 1, wherein the rating functions are discounted rating functions and the determined monetary liability function is a discounted monetary liability function; and
said calculating a third time at which a monetary target is reached by the plurality of meters based on the monetary liability function comprises:
calculating the third time as an intermediate time between the first time and the second time at which a monetary commitment value of the consumer is reached by the plurality of meters based on the discounted monetary liability function.

8. A system, comprising:
a consumption rate determiner configured to determine a linear consumption rate for each of a plurality of meters tracking consumption by a consumer to generate a plurality of linear consumption rates;
a monetary liability function determiner configured to determine a monetary liability function for the consumer based on the plurality of linear consumption rates and a plurality of rating functions associated with the plurality of meters;
a monetary target time calculator configured to calculate an estimated time at which a monetary cap is reached by the plurality of meters based on the monetary liability function; and
a consumption quota calculator configured to calculate a consumption quota for each of the plurality of meters at the estimated time based on a corresponding linear consumption rate to determine a plurality of consumption quotas for the plurality of meters.

9. The system of claim 8, further comprising:
a trigger event monitor configured to determine whether the monetary cap is reached in response to detection of a trigger event.

10. The system of claim 8, further comprising:
a trigger event monitor configured to determine at a second time that a consumption quota of the plurality of consumption quotas corresponding to a meter of the plurality of meters was reached by the meter;
the trigger event monitor configured to determine whether the monetary cap is reached by the plurality of meters based on a reading of the plurality of meters associated with the second time; and
an updated consumption quota being determined for each of the plurality of meters when the monetary cap is determined to not be reached by the plurality of meters.

11. The system of claim 10, wherein the consumption rate determiner is configured to receive a plurality of consumption readings associated with the second time from the plurality of meters, and to determine an updated linear consumption rate for each of the plurality of meters based on the plurality of consumption readings and a plurality of initial consumption values associated with a prior time for the plurality of meters to generate a plurality of updated linear consumption rates;
the monetary liability function determiner configured to determine an updated monetary liability function based on the plurality of updated linear consumption rates and the plurality of rating functions;
the monetary target time calculator configured to calculate an updated estimated time at which the monetary cap is reached by the plurality of meters based on the updated monetary liability function; and
the consumption quota calculator configured to calculate an updated consumption quota for each of the plurality of meters at the updated estimated time based on a corresponding updated linear consumption rate to determine a plurality of updated consumption quotas for the plurality of meters.

12. The system of claim 10, wherein the trigger event monitor is configured to suspend a service associated with the plurality of meters with the consumer when the monetary cap is determined to be reached by the plurality of meters.

13. The system of claim 8, wherein the trigger event monitor is configured to provide the consumer with the estimated time as a projected time at which the monetary cap is reached by the consumer.

14. The system of claim 8, wherein at least one meter of the plurality of meters tracks consumption of data from a data source by the consumer, the consumption rate determiner being configured to receive an indication of an amount of data of the data service consumed by the consumer from the at least one meter.

15. A system, comprising:
a consumption rate determiner configured to receive a plurality of consumption readings associated with an end time of a billing cycle from a plurality of meters tracking consumption, and to determine a consumption rate for each of the plurality of meters based on the received plurality of consumption readings and a plurality of initial consumption values associated with a begin time of the billing cycle to generate a plurality of consumption rates;
a monetary liability function determiner configured to determine a discounted monetary liability function for the consumer based on the plurality of consumption rates and a plurality of discounted rating functions associated with the plurality of meters; and
a monetary target time calculator configured to calculate an intermediate time between the begin time and the end time at which a monetary commitment value of the consumer is reached by the plurality of meters based on the discounted monetary liability function.

16. The system of claim 15, further comprising
a monetary value calculator configured to calculate a monetary value for consumption by the plurality of meters subsequent to the intermediate time until the end time.

17. The system of claim 16, wherein the monetary liability function determiner is configured to determine a non-discounted monetary liability function based on the determined consumption rates and a plurality of non-discounted rating functions associated with the meters, and
the monetary value calculator is configured to calculate the monetary value of the consumption by the plurality of meters from the intermediate time to the end time of the billing cycle based on the non-discounted monetary liability function.

18. The system of claim 15, further comprising:
a monetary value calculator configured to calculate a consumption value reached by the plurality of meters at the intermediate time.

19. The system of claim 15, further comprising:
a bill generator configured to generate a bill for the consumer that includes the monetary commitment value as a first billing amount for the time period from the begin time to the intermediate time, and includes the calculated monetary value as a second billing amount for the time period from the intermediate time to the end time.

20. The system of claim 15, wherein at least one meter of the plurality of meters tracks consumption of data from a data source; and
at the end time, the consumption rate determiner receives an indication from the at least one meter of an amount of data of the data service that is consumed.
